(19) United States
(12) Patent Application Publication
(10) Pub. No.: US 2011/0302119 A1
(43) Pub. Date: Dec. 8, 2011

(54) SELF-ORGANIZING CIRCUITS

(76) Inventor: Alex Nugent, Santa Fe, NM (US)

(21) Appl. No.: 13/113,167

(22) Filed: May 23, 2011

Related U.S. Application Data
(60) Provisional application No. 61/352,490, filed on Jun. 8, 2010.

(51) Int. Cl. G06N 3/04

(52) U.S. Cl. 706/27

(57) ABSTRACT

A self-organizing electronic system and method that organizes and repairs itself. A number circuit of modules can be embedded in a fabric. Each circuit module can calculate some function of its inputs and produces an output, which is encoded on volatile memory held together by a plasticity rule. The plasticity rule allows circuit modules to converge to any possible functional state defined by the structure of the information being processed. Flow through the system gates energy dissipation of the individual circuit modules. Circuit modules receiving high flow become locked in their functional states while circuit modules receiving little or no flow mutate in search of better configurations. These principles can be utilized to configure the state of any functional element within the system, and can be abstracted to higher levels of organization. Far from expending energy on state configurations, a volatile system only expends energy stabilizing successful configurations. Continuous stabilization coupled with redundancy results in a circuit capable of healing itself from the bottom-up.

### CROSS-REFERENCE TO PROVISIONAL APPLICATION

This nonprovisional patent application claims the benefit under 35 U.S.C.§119(e) of U.S. Provisional Patent Application Ser. No. 61/352,490 filed on Jun. 8, 2010, entitled “Self Organizing Circuits,” which is hereby incorporated by reference in its entirety.

### TECHNICAL FIELD

Embodiments are generally related to self-organizing circuits. Embodiments also relate to electronic circuits that can organize and repair themselves. Embodiments also relate to volatile self-organizing electronic techniques and systems.

### BACKGROUND OF THE INVENTION

The electronics industry does not yet understand how nature self-organizes. As a result, solutions are evolved thermodynamically in the human brain and then manually download onto (or into) hardware. Consequently, the circuits and the materials utilized must be perfect because only few mechanisms are available to recover from faults. As chip feature lengths become smaller and wafers become larger, the inability to deal with imperfection begins to consume substantially more resources. To fight this progression, increasingly larger amounts of energy are being expended constructing the most sterile and controlled environments on earth to fabricate the most ridged and non-adaptive systems on earth.

Life is capable of building structures of far greater complexity than any modern chip, and it is capable of doing it while embedded in the real world. Even a rudimentary understanding of the organizing principles of nature will catapult the electronics industry into a new era of productivity. An entirely new class of circuits has to be built that can configure and repair themselves.

Most technology giants currently have active research programs trying to unlock the secrets of self-organization, with emphasis on the human brain. Unfortunately most are trapped in the cycle of their current paradigm for example constructing algorithms that they will run on specialized hardware. Natural evolution is not an algorithm. It is the manifestation of matter interacting according to physical law.

Self organization in Nature is a dissipative structure. For example, imagine a full bathtub. When the plug is removed, the supply of gravitational potential energy is released and the water falls down the drain. Soon a vertical column of air has extended from the surface all the way to the drain. A whirlpool is born. So long as there is water in the tub and a drain to take it away, the whirlpool will remain. Within a few seconds, an Avogadro-scale number of molecules have organized themselves into an entirely new structure. This structure exists because it increases the rate of energy dissipation. Like a rock rolling down hill, a whirlpool results from the inevitable progression of matter acting to lower its energy.

When matter is given a supply of energy it will organize itself into a temporary dissipative structure provided the energy to build and maintain that structure is available. Once the gradient has been dissipated to the point where there is no longer sufficient energy to support the structure, the structure itself is dissipated.

The major application area for self-configuring circuitry is autonomous adaptive control structures. However, the application space is so large it is difficult to see. The entirety of modern computing technology is built from circuitry and programs designed by thermodynamic evolution. Any device that interacts with the real or virtual world, any device capable of being controlled, any information source that can be searched, and any device that interacts with humans need a platform for a new type of electronics. Existing electronic circuits can be reengineered to take advantage of intrinsic adaptability, low costs and the ability to heal.

Therefore, there exists a need for a new type of self-organizing circuit that can configure and organize themselves. Also, the circuits should act to replace sub systems with more efficient adaptive controllers. Cache memory controllers, adaptive routers, novelty detection in manufacturing processes and toys are just some examples. The new generic self-organizing circuit fabric could be used as a resource in many software systems, enabling a large community to develop niche applications. Further, the self-organizing circuitry should also be used as an aid to design static circuits or improve existing designs.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for self-organizing circuits.

It is another aspect of the disclosed embodiments to provide electronic circuits that can organize and repair themselves.

It is yet another aspect of the disclosed embodiments to provide for volatile self-organizing electronic techniques and systems.

The aforementioned aspects and other objectives and advantages can now be achieved as described herein. A self-organizing electronic system and method that organizes and repairs themselves is disclosed. The three basic mechanisms required for electronic self-assembly are volatility, plasticity and flow. These three mechanisms interact to create a self-organization circuit fabric.

The disclosed approach comprises a plurality of circuit modules embedded in a fabric. Each circuit module within the system computes some function of its inputs and produces an output, which is encoded on volatile memory held together by a plasticity rule. The plasticity rule allows circuit modules to converge to any possible functional state defined by the structure of the information being processed.

Flow through the system gates energy dissipation of the individual circuit modules. The circuit modules receiving high flow become locked in their functional states while circuit modules receiving little or no flow mutate in search of better configurations. These principles can be utilized to configure the state of any functional element within a circuit module, and can be abstracted to higher levels of organization. Far from expending energy on state configurations, a volatile system only expends energy stabilizing successful configurations. Continuous stabilization coupled with redundancy results in a circuit capable of healing itself from the bottom-up. Since circuits are stabilized as they become useful, power dissipation only increases as utility increases. Provided that the underlying support circuitry is decentralized, the system can configure itself around faults in the hardware, dramatically increasing chip yields while reducing the need for expensive fabrication technologies.

Some of the core elements needed for a circuit evolution fabric are, for example, a reward detector and one or more circuit modules. Each circuit module can comprise in some embodiments, a dendritic unit, an axonal unit and an energy unit. Sensor inputs can be mapped to a number of circuit modules embedded in the fabric. A portion of the inputs can be mapped to the reward detector, which generates a reward signal when it detects specific regularities in the input data stream, for example the smile of a human. The reward signal can be duplicated and broadcast throughout the fabric.

The dendritic unit can be composed of volatile functional memory. In other words, the volatile memory configures a functional state. Energy needed for the repair of the volatile functional state comes from the energy source units. The axonal unit broadcasts the output state of the dendritic unit to other circuit modules within the fabric. The axonal links are bi-directional, enabling the axonal unit to sum a measure of flow. For example, the axonal unit could sum the combined strength of its plastic output connections or measure the average current sourced and/or sunk. The axonal unit is used to gate the dendritic units access to the energy unit. Some subset of circuit modules are connected to data outputs. The data outputs must have an effect within an environment, causing a change in the sensory input. That is, the circuit fabric must be embedded within an environment.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a schematic diagram of a self-organizing circuit fabric, in accordance with the disclosed embodiments.

FIG. 2 illustrates a schematic diagram depicting the changing of states of volatile and non-volatile memory elements, in accordance with the disclosed embodiments;

FIG. 3 illustrates a schematic diagram of particles in a solution organizing to dissipate a voltage gradient, in accordance with the disclosed embodiments;

FIG. 4 illustrates a schematic diagram of a basic two input node composed of three adaptive and volatile weights, in accordance with the disclosed embodiments;

FIG. 5 illustrates a graphical representation showing a binary input distribution over time and plastic attractor states, in accordance with the disclosed embodiments;

FIG. 6 illustrates a graphical representation of plastic states that emerge from a two dimensional binary data distributions representing fourteen possible states from “A” through “G” each with an anti-state, in accordance with the disclosed embodiments;

FIG. 7A illustrates a vector diagram of two variable system of FIG. 6 showing four vectors, each representing the weight update for each feature, in accordance with the disclosed embodiments;

FIG. 7B illustrates a graph representing the distribution of an anti-symmetric plasticity function, in accordance with the disclosed embodiments;

FIG. 8 illustrates a table of logic function corresponding to each plastic state of FIG. 6, in accordance with the disclosed embodiments;

FIG. 9 illustrates a graph showing the variation of classification error with respect to gradual malfunctions, in accordance with the disclosed embodiments;

FIG. 10A illustrates a schematic diagram of decision surface through time for a static network trained on XOR classification task, in accordance with the disclosed embodiments;

FIG. 10B illustrates a schematic diagram of decision surface through time for an adaptive network trained on XOR classification task, with plasticity governed by AHAH rule, in accordance with the disclosed embodiments;

FIG. 11 illustrates a graphical representation showing distribution of utility with respect to adaptability of volatile system, in accordance with the disclosed embodiments;

FIG. 12 illustrates a schematic diagram showing a volatile self-organizing layer wrapped around a non-volatile core to dissipate energy, in accordance with the disclosed embodiments; and

FIG. 13 illustrates a flowchart explaining a process of self-organizing of electronic circuits, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

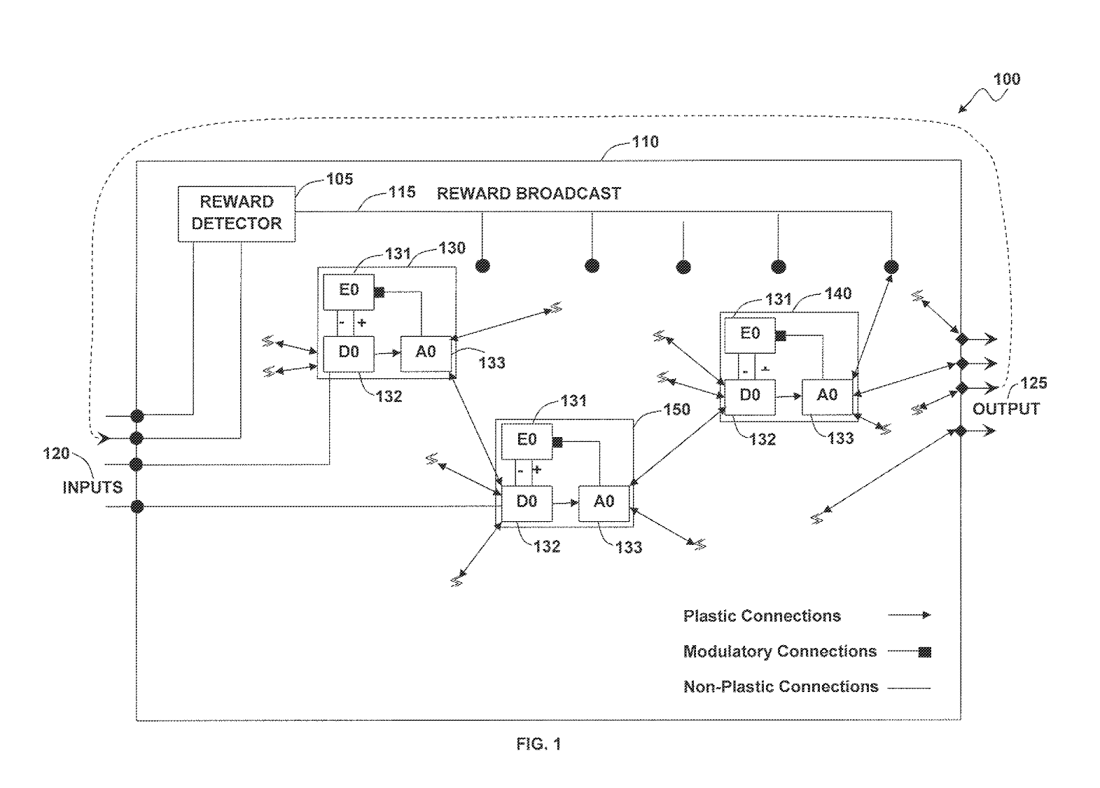

FIG. 1 illustrates a schematic diagram of self-organizing circuit fabric 100, in accordance with the disclosed embodiments. Sensor inputs 120 are mapped to a number of circuit modules 130, 140 and 150 embedded in the fabric 100. A portion of the inputs 120 are mapped to a reward detector 105, which generates a reward signal 115 when it detects specific regularities in the input data stream, for example the smile of a human. The reward signal 115 is duplicated and broadcast throughout the fabric 100. Each circuit modules 130, 140 and 150 contain a dendritic unit 132 an axonal unit 133 and an energy unit 131. The dendritic unit 132 is composed of volatile functional memory. In other words, the volatile memory configures a functional state.

Energy needed for the repair of the volatile functional state comes from the energy source units. Each axonal unit 133 in a circuit module for example the circuit module 130 broadcasts the output state of the dendritic unit 132 to other circuit modules for example the circuit module 150 within the fabric 100. The axonal links are bi-directional, enabling the axonal unit 133 to sum a measure of flow. For example, the axonal unit 133 could sum the combined strength of its plastic output connections or measure the average current sourced and/or sunk by the axonal unit. The axonal unit 133 is used to gate the dendritic units 132 access to the energy unit 131. Some subset of circuit modules for example the circuit module 140 are connected to data outputs 125. The data outputs 125 must have an affect on an environment 110, causing a change in the sensory input 120, that is, the circuit fabric 100 must be embedded within an environment 110.

Life is the only example of a system capable of natural self-organization and intelligence, and volatility defines life. Life is a characteristic that distinguishes objects that have signaling and self-sustaining processes from those that do not, either because such functions have ceased (death), or else because they lack such functions and are classified as inanimate. By failing to exploit volatility, modern electronics has been relegated to a small backwater of static, pre-defined structures.

The three basic mechanisms required for electronic self assembly are volatility, plasticity and flow. Volatility, plasticity and flow interact to create a self-organization circuit fabric.

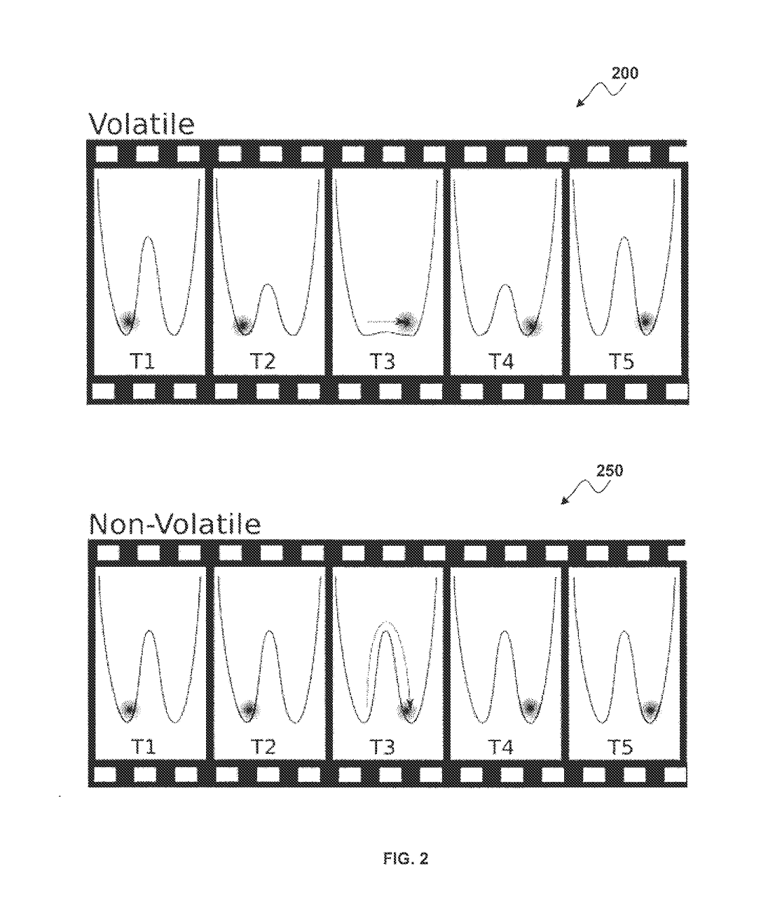

FIG. 2 illustrates a schematic diagram depicting the changing states of volatile and non-volatile memory elements 200 and 250 respectively, in accordance with the disclosed embodiments. Two switches (not shown) are considered in which the first switch is volatile, so that its state is constantly refreshed or repaired. The second switch is non-volatile, impervious to background energy fluctuations.

Abstractly, a switch can be represented as a potential energy distribution with two or more minima. In the non-volatile memory element 250 the initial state represented by the black dot, is changed at t=3. Sufficient energy must be applied to overcome the barrier. As the switch settles into its new state the energy is dissipated in proportion to the barrier height. Rather than just the switch, the whole configuration electrode must be raised to a voltage on par with the switch barrier energy. If everything is adapting at all times, then energy is provided for adaptation to everything at all times. Power goes as the square of voltage, so small increases in voltages leads to large power dissipations. The consequence of this is that very large scale adaptive systems consume prodigious amounts of energy if composed of non-volatile memory elements.

In case of volatile memory element 200, rather than applying energy, energy is taken away. As the switch dissipates less energy its barriers begin to fall until the energy inherent in thermal fluctuations causes spontaneous state transitions. When energy is dissipated across the switch, the barriers will rise and the new state will stabilize.

There is a profound difference between these two types of state transitions. In the non-volatile case the energy needed to effect a state transition originates from outside the system. In the volatile case, the energy to effect a state transition came from the switch itself. One switch was programmed while the other programmed itself. One switch requires more energy to transition and the other requires less energy. In the volatile case, if there is a choice between two states, and one option leads to more energy dissipation, it is vastly more likely that the switch will find itself in that state over time because energy barriers are erected to prevent the state from decaying. This is the core driver of self-organizing volatile circuits, as described in this disclosure.

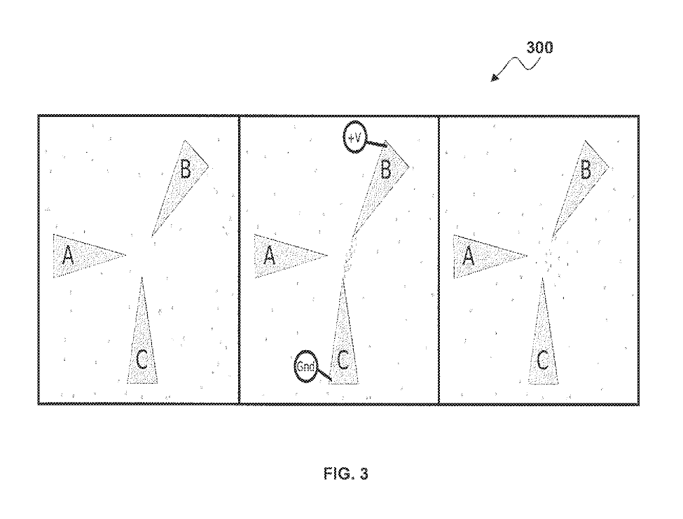

FIG. 3 illustrates a schematic diagram of a volatile switch assembly 300 comprising particles in a solution organize to dissipate a voltage gradient, in accordance with the disclosed embodiments. Three electrodes (A, B and C) are immersed in a liquid/particle solution and a voltage is applied across electrodes B and C. At this instant an inhomogeneous electric field is generated across the two electrodes. The electric field induces dipoles in nearby particles, which feel a force that draws them in. In short time the particles have assembled into a wire bridging the two electrodes. If a particle were to break loose, a strong electric field would be generated that would pull the assembly back together. So long as electricity is flowing (energy is being dissipated) the wire will repair itself to channel the flow. When the energy is depleted, the structure will dissolve back into solution.

Self organization of parts can only occur if the parts are free to move. Nature must have access to some degrees of freedom, and if it does it will navigate those degrees of freedom toward higher energy dissipation rates. For a system to configure itself, rather than be configured, then it must be volatile.

Volatility enables continuous adaptation in very high densities at low power dissipations that are not otherwise possible. Rather than expeding vast amounts of energy to prevent volatility, far less energy can be used to repair. Providing constant low-power is far cheaper and more flexible than intermittent high power, and it is the only viable commercial option for large scale self-organizing circuitry.

Flow is all around us. Human brains, bodies, companies and the world's economies all function because of flow. Flow is the mechanism that allows individuals to work together toward one unified goal. To understand the concept of flow, economic structure can be considered. Money binds people together into large companies. If a company fails to pays its employees, employees may looking for other work. However, it is not quite that simple. For the employees to be bound to the companies, employees must also spend money. A person who does not spend money has no need for money and cannot be bound by the system. The force that binds individuals together in an economy is the flow of money through them.

Consider another example. It has been known for some time that nerve growth factors (NGF) produced in human brains are needed for a neuron to survive and grow. Neuron survive when only their terminals are treated with NGF indicating that NGF available to axons can generate and retrogradely transport the signaling required for the cell body. NGF must be taken up in the neuron's axon and flow backward toward the neuron's body, stabilizing the pathway exposed to the flow. Without this flow, the neuron's axon will decay and the cell will eventually kill itself. In the particle system of FIG. 3, it is electrons that are flowing. It is the flow of electrons that keeps the particles in the assembly.

For units to self-organize into a large assembly a flow of a substance through the units that gates access to the units energy dissipation is to be provided. Money, for example, flows through the economy and gates access to energy. It is a token that is used to unlock local energy reserves and stabilize successful structure. Just as NGF flows backward through a neuron from its axons, money flows backwards through an economy from the products that are sold to the manufacturing systems that produced them.

If the organized structure is to persist, the substance that is flowing must itself be an accurate representation of the energy dissipation of the assembly. If it is not, then the assembly will eventually decay as local energy reserves run out. In the case of the particle chain, the flow actually is energy dissipation. Money and NGF are each tokens or variables that represent energy flow. In both cases, flow gates access to energy by releasing local reserves or providing it directly.

Flow solves the problem of how units within an assembly come to occupy states critical to global function via purely local interactions. If a unit's configuration state is based on volatile memory and this memory is repaired with energy that is gated by flow, then its state will transition if its flow is terminated or reduced. When a new configuration is found that leads to flow it will be stabilized. The unit does not have to understand the global function. So long as it can maintain flow it knows it is useful. In this way units can organize into assemblies and direct their local adaptations toward higher and higher levels of energy dissipation. Flow resolves the so-called plasticity-stability dilemma. If a node cannot generate flow, then it is not useful to the global network function and can be mutated without consequence.

Out of all ways two units of matter can interact to dissipate energy, a plasticity rule describes what interactions are possible. At the most fundamental level they are the fundamental forces of physics. DNA represents the plasticity rule of living systems, and human law represents the plasticity rules of society. We all wake up each morning and dissipate energy within the constraints of the law. The cells in human body dissipate energy subject to the constraints of its DNA. By changing the set of allowable interactions the type of global organization can be affected. Some rules leads to a small number of simple structures while others lead to a universe of possibilities. We are of course interested in the later. One simple rule capable of configuring universal computational states is the AHAH rule. The Anti-Hebbian And Hebbian (AHAH) rule states that the connection between two units is modified in such a way as to facilitate the transfer of the sender's state to the receiver's state.

The AHAH rule can be understood from a broader system perspective. Each unit within an assembly is held in an attractor state that represents some functional configuration. A plasticity rule creates these attractor states by the continual application of positive feedback. Whatever functional state the unit happens to be in, it simply attempts to adjust connections so as to stay in that state.

This rule is defined across a number of modalities, including spike timing and activity. The rule can be applied across different modalities at the same time, for example adjusting the connections based on precise timing and also averaged firing.

All functional aspects of a self-organizing network of interacting units can ultimately be brought under the control of this one very powerful rule.

The AHAH rule is capable of generating attractor states allowing the network to compute any possible logic function, provide optimal classifications, and dynamically adjust connections in response to faults.

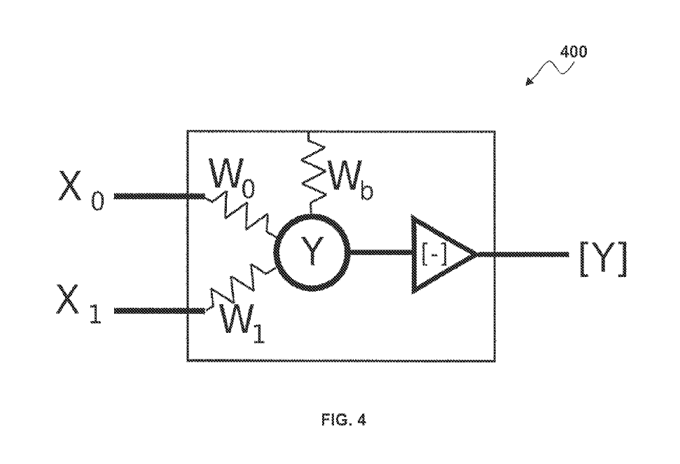

FIG. 4 illustrates a schematic diagram of a basic two input node 400 composed of three adaptive and volatile weights, in accordance with the disclosed embodiments.

Consider the standard linear model defined by an equation (1) below:

Y=w₀x₀+w₁x₁+w_{b} (1)

Each inputs is multiplied by a weight and summed together to form Y. W_{b} is a bias weight and is formed between the boundaries of the node. This can be understood as a weight connected to an input that is always in one state. The output of the node is forced to take one of two states for example “+1” or “−1” via the application of the bracket operator [Y], where [Y] is “1” if Y≧0 and “−1” if Y≦0. The bracket operator is nothing more than positive feedback applied to an initial state.

Every time a weight is used, it is modified by the following instance of the AHAH rule. This modification can indicated in equation (2) as follows:

Δwᵢ=αxᵢYe=αxᵢf(Y) (2)

Where Δwᵢ is the modification to the i^{th} synapse, α is the learning rate which can be modulated by flow, xᵢ is the i^{th} input, and σ is a constant that controls a key nonlinearity enabling the rule to extract independent components.

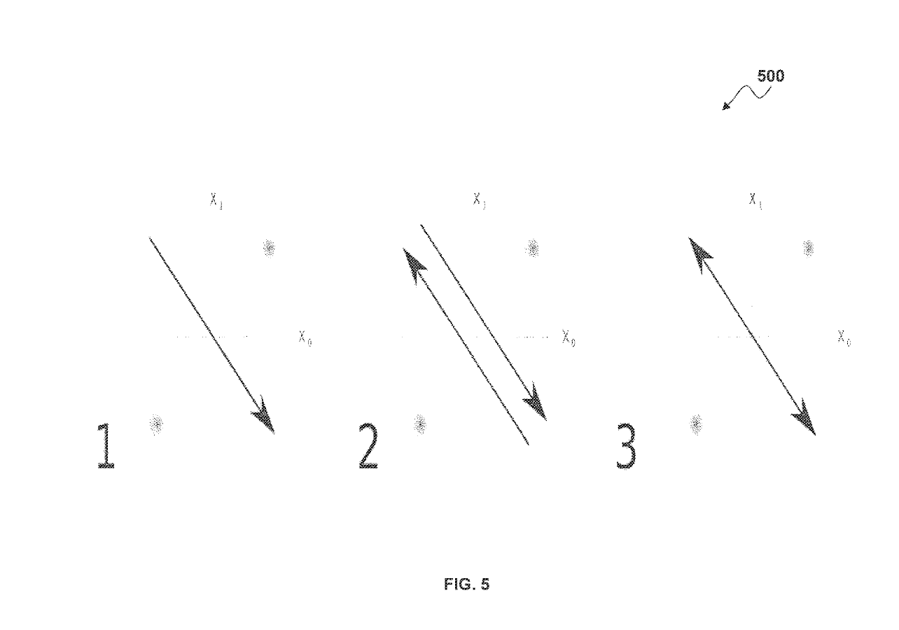

FIG. 5 illustrates a graphical representation showing input distribution 500 over time, in accordance with the disclosed embodiments. To get a feel for how this rule functions, two inputs can be considered and a distribution 500 can be plotted over time. On this same distribution the decision boundary of the node can be drawn. All inputs on the left side result in the node being in the negative state, and all inputs on the right side are in the positive state. To distinguish right and left the line as an arrow can be drawn and the right hand rule can be utilized. In this example, only two binary input patterns are present: [1,1] and [−1,−1], resulting in two attractor states denoted by arrows.

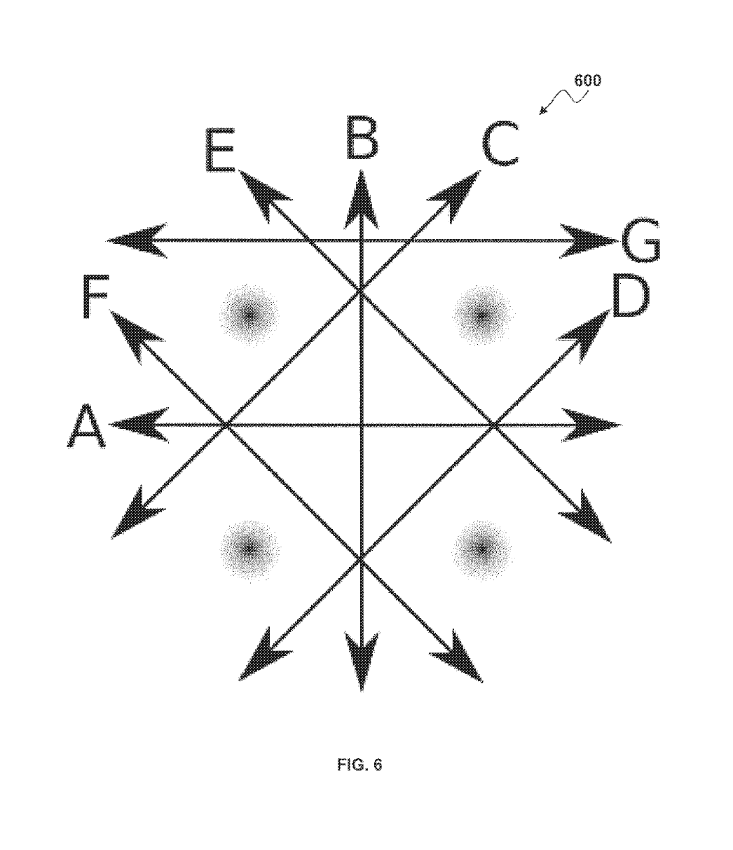

FIG. 6 illustrates a graphical representation 600 of a two variable system of FIG. 4 representing fourteen possible states 600 from “A” through “G” , each with an anti-state, in accordance with the disclosed embodiments. For the binary distribution two observations are made. First, the rule acts to bisect the data structure. Second, for each state there is an anti-state, which means the decision boundary can be drawn as a double-pointed arrow. The input data distribution is expanded to allow all possible binary input patterns to identify 14 unique states, “A” through “G”, each with its anti-state. Of particular interest are states “C”, “D”, “E” and “F”, which cannot occur unless two properties hold. First, there must be a bias weight w_{b}. Second, f(Y) must approach zero as Y−>±∞.

The first property is clear by noting that the decision boundary cannot be drawn without a bias. The second property is much more subtle, but important. Imagine that the weight vector was in the “E” state and rule is suddenly changed to the Equation (3) as shown below:

Δwᵢ=αxᵢY (3)

If the sum of the updates over all the inputs is zero, then the state is stable. Equation (2) and Equation (3) both modify the weights in the direction that will push the decision boundary further from the feature. A stable point exists when features on opposite sides of the decision boundary push against each other with equal and opposite intensity. If the state is imbalanced, such that the decision boundary splits the features into unequal sets, a linear rule such as Equation (3) cannot handle the imbalance.

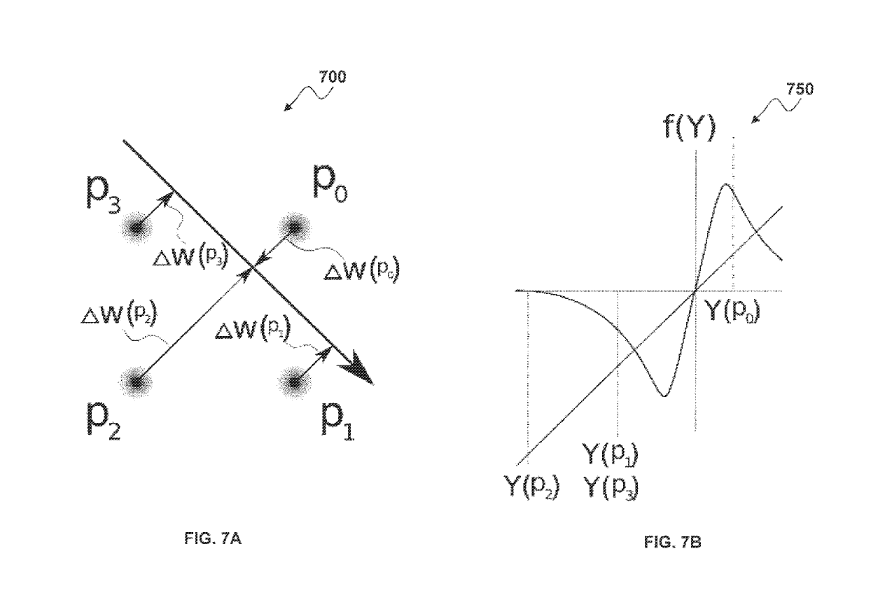

FIG. 7A illustrates a vector diagram 700 of two variable system of FIG. 4 showing three vectors, each representing the weight update for each feature, in accordance with the disclosed embodiments. FIG. 7B illustrates a graph 750 representing the anti-symmetric AHAH plasticity function, in accordance with the disclosed embodiments. The update from p₁, p₂ and p₃ completely overwhelms the update from p₀, if the rule is linear. However, if the rule is of the form of Equation (2), then the update from p₂ effectively goes to zero, and a slight offset of the decision boundary results in the p₀ update balancing the combined updates from p₁ and p₃.

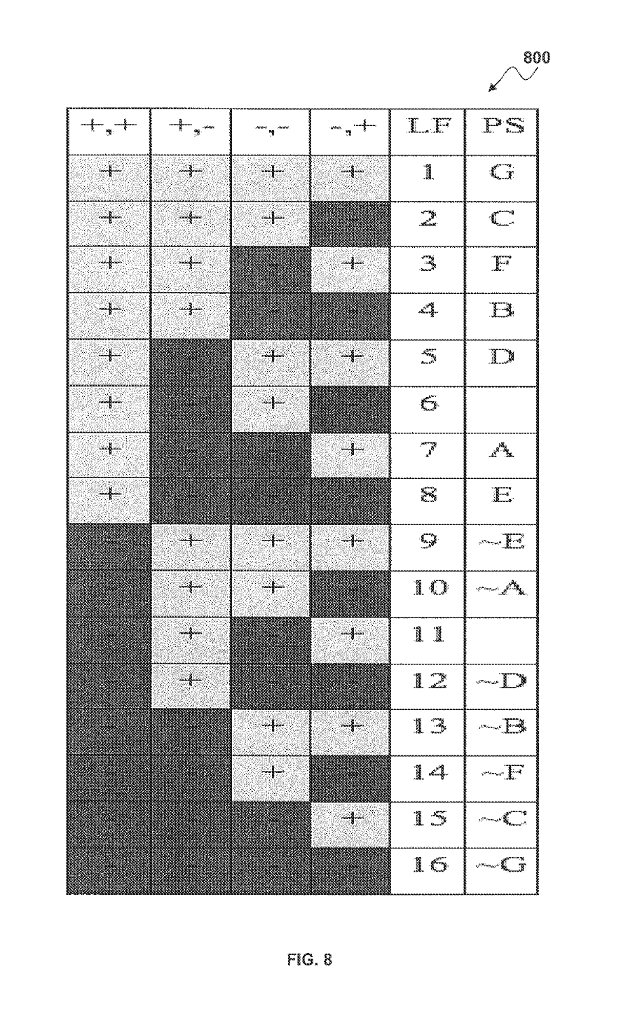

FIG. 8 illustrates a table 800 of a two input one output gate showing the logic function corresponding to each plastic state, in accordance with the disclosed embodiments. Each of the 14 states depicted in FIG. 6 can be related to logic functions. The reason it is important that states “C” though “G” are stable is that they are required to form a computationally complete set of logic functions. It is clear from table 800 that almost all logic functions are represented, with only the XOR functions missing (as expected). These functions, or any function of more inputs and outputs, can be attained simply by combing multiple nodes in various plastic states together. However, it is only possible to derive all logic functions from a smaller set if that set includes one of the “C” through “G” states. Therefore there exists a need for the nonlinearity of Equation (2) to achieve attractor states capable of universal logic.

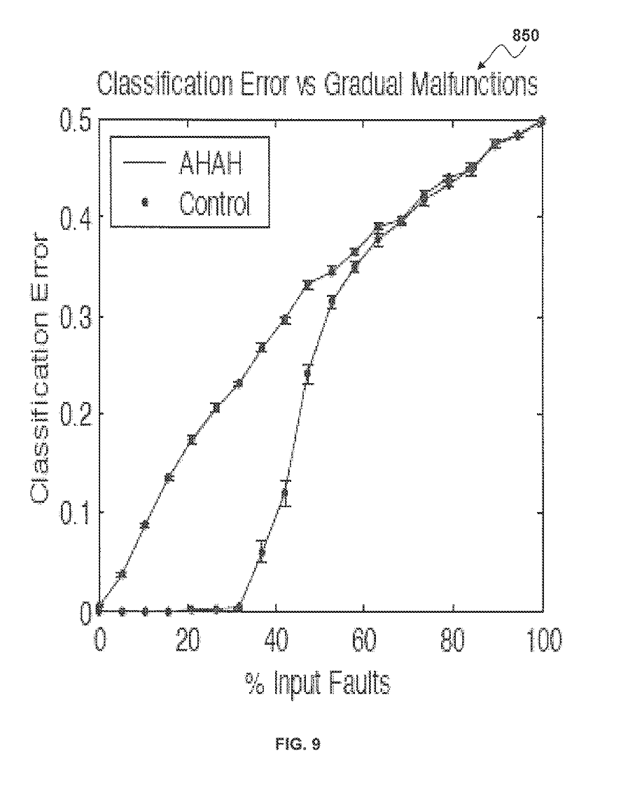

FIG. 9 illustrates a graph 850 showing the variation of classification error with respect to gradual malfunctions of a pattern recognition system (not shown), in accordance with the disclosed embodiments. The rule described by Equation (2) will converge to stable partitions that act to constantly maximize support vectors. Rather than interpreting the plastic states as logic functions, it can be seen as optimal classification states. For example, if a network is trained using a Support Vector Machine (SVM) on a subset of data and then run with Equation (2) over the remaining data set, the classification rate will become better over time as it converges to the optimal classification boundary. The theory of SVM's provide a rigorous solution to the problem of generalization versus memorization common to neural network training. The implication is that this same plasticity rule can converge to a solution consistent with the theoretical understanding of what the optimal decision boundary is for a classification task.

Provided some degree of redundancy in the input information the rule will adjust the weights in response to faults or failures. If an input line becomes unresponsive, evolves to represent another regularity, or becomes random, the rule will adjust every weight in just the right amount to maintain its functional state. The result is a circuit that can heal itself from the bottom up with no centralized controller.

These are fundamentally the same mechanisms that occur in life. For example, if a small cut is received, the human body will regenerate and return to its initial state. This is only possible because human body is in an attractor state, constantly restoring any deviations that may occur. These self-healing mechanisms will have profound effects on electronics. As a circuit is used it will become better, just as exercise makes human healthier.

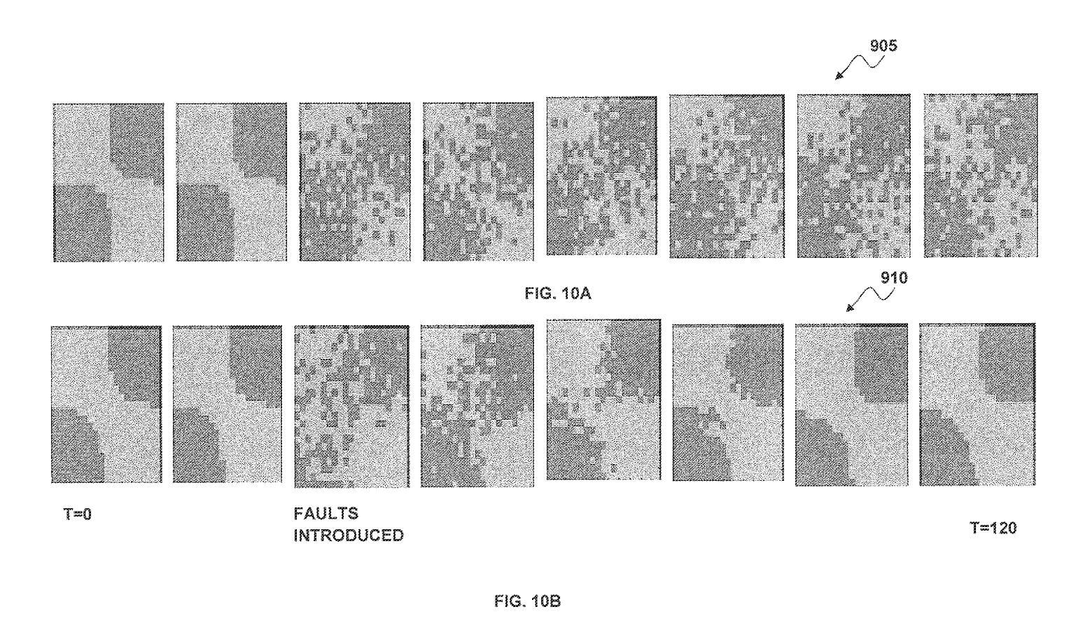

FIG. 10A illustrates a schematic diagram of decision surface 905 through time for a static network trained on XOR classification task, with plasticity governed by AHAH rule, in accordance with the disclosed embodiments. FIG. 10B illustrates a schematic diagram of decision surface 910 through time for an adaptive network trained on XOR classification task, with plasticity governed by AHAH rule, in accordance with the disclosed embodiments. At the time step indicated, faults were injected into the network, causing the corresponding synapses to become unreliable. The adaptive network can heal itself because its state is pined to the structure of the data stream and not that of intrinsic configuration bits.

To review, the AHAH rule is capable of creating attractor states that can be configured through unsupervised mechanisms to perform directed universal computation, coincides with the theoretical understanding of optimal pattern classification and are capable of repairing a functional state within a volatile, constantly shifting environment. Rather than a technology that fails from the slightest hint of uncertainly, a new paradigm exists that is only possible because of it. It can operate at energy dissipations that are many orders of magnitude less than anything possible using conventional approaches. Fundamental physical limitations prevent classical computing systems from touching the power of volatile adaptive systems.

Self-organizing circuitry is useless unless its evolution is directed, and as explained, circuits will evolve to maximize flow. Imagine a circuit evolution fabric (“cortex”) with many data inputs streaming into it. Each input into this cortex arrives via the modulation of a sensory node. To guide the evolution of circuit, the ultimate source of flow must coincide with the prediction of satisfying the task that is desirable. By creating a reward signal and massively duplicating it, the largest source of stabilization can be insured.

The only source of stabilization is flow resulting from the prediction of information. Stabilization can occur from three main sources. The first source is the prediction of regularities in the data stream originating external to the circuit. As an example, consider the pixels from a video. As an object moves across the screen, the detection of some regularity coupled with the direction of movement is sufficient to predict that the regularity will appear at another position on the screen. The second source is the prediction of a proprioceptive sense. Circuit stability is insured if a circuit can initiate a motor action and simultaneously predict the patterns of proprioceptive sensor activations that result. This source of prediction is very stable because it is self-fulfilling, i.e., direct positive feedback. The third source of stabilization is the prediction of reward. By duplicating the reward signal, domination over any other potential source of prediction can simply be ensured. This pattern can clearly be seen in brains, as the structures linked to reward are massive signal duplication circuits. Any circuit that can predict the reward signal will be ensured of stabilization, wherever it is, because the reward signal is everywhere. Furthermore, the energy attained from stabilization can be directed toward growth, enabling the circuit to extend its functional state throughout the entire assembly.

The energy required for the repair of a volatile system is many orders of magnitude less than making a nonvolatile system adaptive. This reduction is what will make adaptive systems commercially viable. Consider that the human brain, arguably the most capable self-organizing circuit currently in existence, dissipates only 10 W. Simplified computer simulations of biological-scale neural networks exceed 1 MW. It is not commercially viable to construct a circuit capable of human-level cognitive function that dissipated 1 MW.

The brain is the quintessential self-organizing circuit, and every brain in existence has evolved to control a mobile structure. Robotics is therefore an obvious first application for self-organizing circuitry. Control systems can operate at vastly reduced levels of intelligence compared to a human and still command huge utility, but only if the power consumption can be supported by the platform.

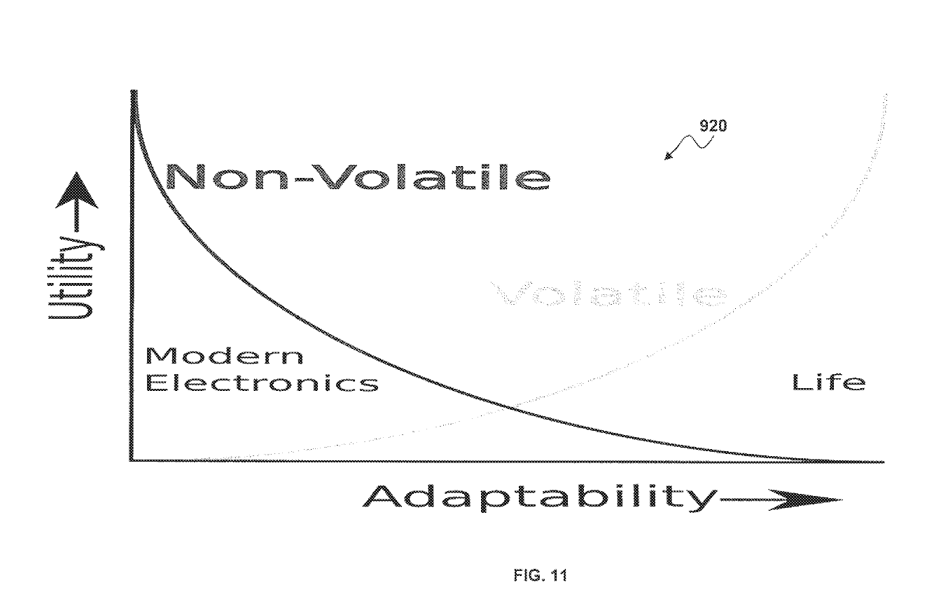

FIG. 11 illustrates a graphical representation 920 showing distribution of utility with respect to adaptability of volatile and non-volatile system, in accordance with the disclosed embodiments. There is a fundamental tradeoff between volatile and non-volatile systems, and their application spaces support each other. In cases where rigorous algorithmic solutions exist with little adaptability, a nonvolatile system is superior. In complex, ever-changing environments where solutions must be evolved or searched continuously, volatile systems are superior. In many cases, the optimal solution will require both.

The microelectronics industry was not started overnight by constructing microprocessors. The first products were simple logic circuits. Through a process of evolution the industry built on its success to reach billion-transistor microprocessors of today. It is unreasonable to assume that the first ventures into self-organizing circuitry will match the intelligence of a human, a cat, a rat or even a mouse. To succeed, the expectations have to be substantially lower for the first generation of self-organizing circuits. Reduced expectations are only useful if they are both cheap and power efficient. Power needlessly spent on reconfiguring the states of non-volatile memory elements vastly exceeds all reasonable power budgets for most (or all) mobile application platforms. Consequently, the only reasonable path to commercialization is through volatile structures.

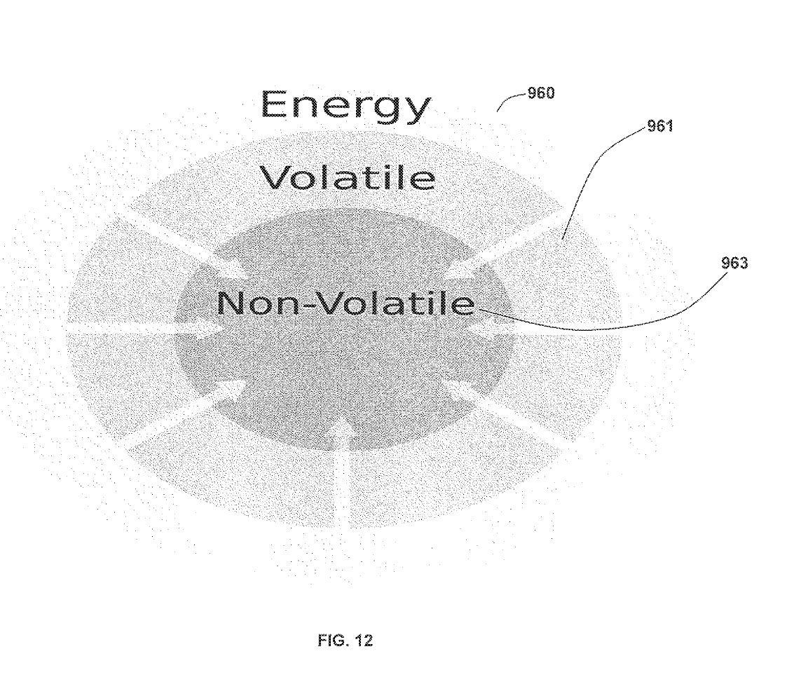

FIG. 12 illustrates a schematic diagram showing a volatile self-organizing layer 961 wrapped around a non-volatile core 963 to dissipate energy 960, in accordance with the disclosed embodiments. Modern technology represents the end product of a volatile system organizing itself to dissipate energy 960. Just as a tree converts sunlight into structure, building a new ring each year, the electronics industry is a volatile shell that converts energy reserves into nonvolatile electronics. The entire computing paradigm is built on this principle. “Software” is the non-volatile end-product of a volatile system (Human brains) dissipating energy. The next paradigm in electronics will be born of a volatile self-organizing layer 961 wrapped around a non-volatile core 963. Volatile self-organizing circuitry will be capable of computing functions that are not yet imagined. Volatile self-organizing circuitry application space will be larger than anything that currently exists and it will be cheaper than anything built yet.

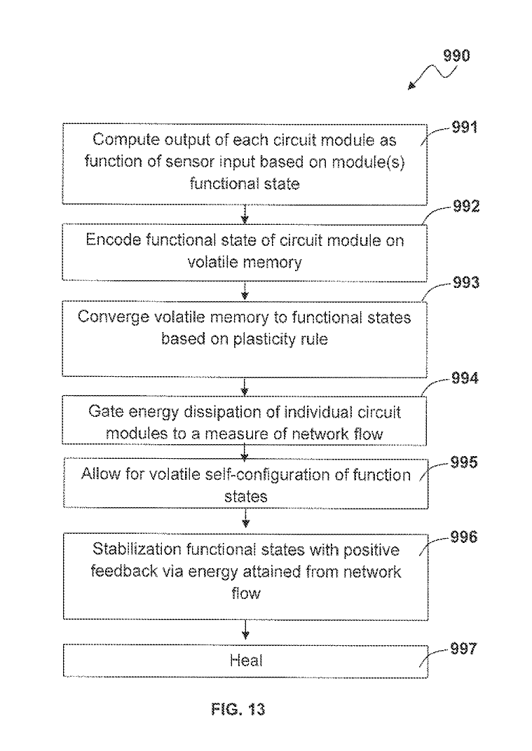

FIG. 13 illustrates a high-level flowchart of operations depicting logical operations of a method 990 for self-organizing electronic circuits, in accordance with the disclosed embodiments. The basic mechanisms such as volatility, plasticity and flow of self-organizing electronic systems are clear from FIG. 1 to FIG. 12. The self-organizing system comprises a plurality of circuit modules embedded in a fabric. Each circuit module also referred as units within the system may compute some function of its inputs and produce an output, which is encoded on volatile memory held together by a plasticity rule as illustrated at block 991 and 992. Then, as illustrated at block 993, the plasticity rule allows circuit modules to converge to any possible functional state defined by the structure of the information being processed. Flow through the system gates energy dissipation of the individual circuit modules as depicted at block 994.

The circuit modules that receive high flow becomes locked in their functional states while circuit modules that receive little or no flow mutate in search of better configurations. These principles can be used to configure the state of any functional element within system, and can be abstracted to higher levels of organization as the at block 995. Rather expending energy on state configurations, a volatile system only expends energy stabilizing successful configurations as depicted at block 996. Finally, as illustrated at block 997 continuous stabilization coupled with redundancy results in a circuit capable of healing itself from the bottom up. Since circuits are stabilized as they become useful, power dissipation only increases as utility increases. Provided that the underlying support circuitry is decentralized, the system will configure itself around faults in the hardware, dramatically increasing chip yields while reducing the need for expensive fabrication technologies

Note that a mathematical model should not be confused with a physical system. Although mathematics and computers can be utilized to illustrate concepts, self-organizing circuits of high utility cannot be built from them, as it would consume vastly too much energy. Equations illustrated herein are meant to generally describe a physical process, not a computational process.

Based on the foregoing, it can be appreciated preferred and alternative embodiments are disclosed. For example, in one embodiment, a self-organizing circuit can be implemented, which includes a reward detector for generating a reward signal upon detecting specific regularities in input data stream, and a processing unit for duplicating and broadcasting the reward signal throughout a fabric in which the self-organizing circuit is configured The self-organizing circuit can further include a plurality of circuit modules embedded in the fabric, wherein each circuit module among the plurality of circuit modules comprises a dendritic unit, an axonal unit and an energy unit, the dendritic unit comprising a volatile functional memory.

In another embodiment, the volatile functional memory can be governed by a plasticity rule. In yet another embodiment, the volatile functional memory can comprise one or more volatile functional states. In still another embodiment, the aforementioned circuit module can compute a particular function of inputs to the circuit module to produce an output that is encoded with respect to the volatile functional memory, the volatile functional memory governed by a plasticity rule. In still another embodiment, the energy needed to repair the volatile functional state can derive from the energy unit. In other embodiments, the axonal unit can broadcast an output state of the dendritic unit to at least one other circuit module among the plurality of circuit modules within the fabric. In another embodiment, the axonal unit can comprise a plurality of links, wherein the plurality of links of the axonal unit are bi-directional and allow the axonal unit to sum a measure of flow. In yet another embodiment, the circuit modules among the plurality of circuit modules which receive a high flow can be locked into respective functional states. In other embodiments, the circuit modules among the plurality of circuit modules which receive little or no flow can mutate in search of better configurations.

In another embodiment, a method for configuring a self-organizing circuit can be implemented which includes operations for generating a reward signal upon detecting specific regularities in input data stream, duplicating and broadcasting the reward signal throughout a fabric in which the self-organizing circuit is configured, and embedding a plurality of circuit modules embedded in the fabric, wherein each circuit module among the plurality of circuit modules comprises a dendritic unit, an axonal unit and an energy unit, the dendritic unit comprising a volatile functional memory. In another embodiment, an operation can be implemented for governing the volatile functional memory by a plasticity rule.

It will be appreciated that variations of the above disclosed apparatus and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A system for a self-organizing circuit, comprising:
a reward detector for generating a reward signal upon detecting specific regularities in input data stream;
a processing unit for duplicating and broadcasting said reward signal throughout a fabric in which said self-organizing circuit is configured; and
a plurality of circuit modules embedded in said fabric, wherein each circuit module among said plurality of circuit modules comprises a dendritic unit, an axonal unit and an energy unit, said dendritic unit comprising a volatile functional memory.

2. The system of claim 1 said volatile functional memory is governed by a plasticity rule.

3. The system of claim 1 wherein said volatile functional memory includes at least one volatile functional state.

4. The system of claim 1 wherein said circuit module computes a particular function of inputs to said circuit module to produce an output that is encoded with respect to said volatile functional memory, said volatile functional memory governed by a plasticity rule.

5. The system of claim 3 wherein energy needed to repair said volatile functional state derives from said energy unit.

6. The system of claim 1 wherein said axonal unit broadcasts an output state of said dendritic unit to at least one other circuit module among said plurality of circuit modules within said fabric.

7. The system of claim 1 wherein said axonal unit comprises a plurality of links, wherein said plurality of links of said axonal unit are bi-directional and allow said axonal unit to sum a measure of flow.

8. The system of claim 1 wherein circuit modules among said plurality of circuit modules which receive a high flow are locked into respective functional states.

9. The system of claim 1 wherein circuit modules among said plurality of circuit modules which receive little or no flow mutate in search of better configurations.

10. A system for a self-organizing circuit, comprising:
a reward detector for generating a reward signal upon detecting specific regularities in input data stream;
a processing unit for duplicating and broadcasting said reward signal throughout a fabric in which said self-organizing circuit is configured; and
a plurality of circuit modules embedded in said fabric, wherein each circuit module among said plurality of circuit modules comprises a dendritic unit, an axonal unit and an energy unit, said dendritic unit comprising a volatile functional memory, wherein said volatile functional memory is governed by a plasticity rule.

11. The system of claim 10 wherein said volatile functional memory includes at least one volatile functional state.

12. The system of claim 10 wherein said circuit module computes a particular function of inputs to said circuit module to produce an output that is encoded with respect to said volatile functional memory, said volatile functional memory governed by a plasticity rule.

13. The system of claim 12 wherein energy needed to repair said volatile functional state derives from said energy unit.

14. The system of claim 10 wherein said axonal unit broadcasts an output state of said dendritic unit to at least one other circuit module among said plurality of circuit modules within said fabric.

15. The system of claim 10 wherein said axonal unit comprises a plurality of links, wherein said plurality of links of said axonal unit are bi-directional and allow said axonal unit to sum a measure of flow.

16. The system of claim 10 wherein circuit modules among said plurality of circuit modules which receive a high flow are locked into respective functional states.

17. The system of claim 10 wherein circuit modules among said plurality of circuit modules which receive little or no flow mutate in search of better configurations.

18. A method for configuring a self-organizing circuit, said method comprising:
generating a reward signal upon detecting specific regularities in an input data stream;
duplicating and broadcasting said reward signal throughout a fabric in which said self-organizing circuit is configured;
embedding a plurality of circuit modules embedded in said fabric, wherein each circuit module among said plurality of circuit modules comprises a dendritic unit, an axonal unit and an energy unit, said dendritic unit comprising a volatile functional memory; and
governing said volatile functional memory by said plasticity rule.

19. The method of claim 18 further comprising configuring said volatile functional memory to comprise at least one volatile functional state.

20. The method of claim 18 wherein:
said circuit module computes a particular function of inputs to said circuit module to produce an output that is encoded with respect to said volatile functional memory; and
wherein energy needed to repair said volatile functional state derives from said energy unit.
